(19) United States
(12) Patent Application Publication
(10) Pub. No.: US 2005/0107544 A1
(43) Pub. Date: May 19, 2005

(54) Plasma resistant curable fluoroelastomer composition

(76) Inventor: Shuhong Wang, Hockessin, DE (US)

Correspondence Address: DUPONT DOW ELASTOMERS, LLC;PATENT RECORDS CENTER, 4417 LANCASTER PIKE, BARLEY MILL PLAZA 25, WILMINGTON, DE, 19805, US

(21) Appl. No.: 10/963,021

(22) Filed: Oct. 12, 2004

Related U.S. Application Data
(60) Provisional application No. 60/519,688, filed on Nov. 13, 2003.

(51) Int. Cl. C08F 14/18

(52) U.S. Cl. 525/326.2

(57) ABSTRACT

A fluoroelastomer composition comprising a) a fluoroelastomer, b) a curative and c) barium sulfate having an average particle size less than 200 nm is disclosed. This composition loses less weight and produces fewer particles when exposed to reactive plasmas than do similar compositions which contain larger particle size barium sulfate.

### CROSS-REFERENCE TO RELATED APPLICATIONS

This application claims the benefit of U.S. Provisional Application No. 60/519,688 filed Nov. 13, 2003.

### FIELD OF THE INVENTION

This invention relates to fluoroelastomer compositions comprising a) fluoroelastomer, b) curative and c) barium sulfate filler, said barium sulfate having an average particle size less than 200 nm.

### BACKGROUND OF THE INVENTION

Fluoroelastomers have achieved outstanding commercial success and are used in a wide variety of applications in which severe environments are encountered, in particular those end uses where exposure to high temperatures and aggressive chemicals occurs. These polymers are often used in seals for aircraft engines, in oil-well drilling devices, in semiconductor wafer manufacturing processes and in sealing elements for industrial equipment used at high temperatures.

Such materials are commercially available and are most commonly copolymers of vinylidene fluoride (VF₂) with hexafluoropropylene (HFP) and, optionally, tetrafluoroethylene (TFE). Other known fluoroelastomers include copolymers of TFE with a perfluoro(alkyl vinyl ether) such as perfluoro(methyl vinyl ether) (PMVE), copolymers of TFE with propylene (P) and, optionally VF₂, and copolymers of ethylene (E) with TFE and PMVE. Often, these fluoroelastomers also contain copolymerized units of a cure site monomer to facilitate vulcanization.

Many fluoroelastomer seals are filled with carbon black. However, an increasing number of end use applications require non-black seals. White fillers such as silica, barium sulfate, alumina and aluminum silicate are generally employed for such applications (U.S. Pat. Nos. 5,696,189 and 6,191,208 B1). The barium sulfate generally employed in fluoroelastomer compositions has an average particle size of at least 0.7 microns. Seals that contain the latter size barium sulfate particles lose a moderate amount of weight, due to decomposition, when the seals are exposed to a reactive plasma such as that found in semiconductor chip manufacturing. The resulting decomposition products can contaminate the chip. It would be desirable to have white fluoroelastomer compositions which are filled with barium sulfate and which do not lose a moderate amount of weight when exposed to reactive plasmas.

### SUMMARY OF THE INVENTION

The present invention is directed to a curable fluoroelastomer composition that, when cured, has good physical properties, particularly good (i.e. low) compression set. Furthermore, the fluoroelastomer compositions experience reduced weight loss when exposed to reactive plasmas than do similar compositions that contain barium sulfate having particle sizes of about 0.7 microns or larger. Accordingly, an aspect of the present invention is a curable composition comprising
A. a fluoroelastomer;
B. a curative; and
C. 0.1 to 50 parts by weight barium sulfate per hundred parts by weight fluoroelastomer, said barium sulfate having an average particle size of less than 200 nm.

### DETAILED DESCRIPTION OF THE INVENTION

The compositions of the present invention are based on elastomeric fluoropolymers (hereinafter “fluoroelastomers”) which, when cured, exhibit an elastomeric character.

One type of fluoroelastomer which may be employed in the compositions of this invention is based on vinylidene fluoride (VF₂). In addition to copolymerized units of VF₂, this type of fluoroelastomer contains copolymerized units of at least one other fluorine-containing monomer. Examples of such monomers include, but are not limited to hexafluoropropylene (HFP), tetrafluoroethylene (TFE), chlorotrifluoroethylene (CTFE), fluorinated vinyl ethers (FVE) and perfluoro(alkyl vinyl) ethers (PAVE). In addition, the fluoroelastomers may optionally contain copolymerized units of methyl vinyl ether, or an olefin such as ethylene (E) or propylene (P).

Another type of fluoroelastomer which may be employed in this invention is based on tetrafluoroethylene (TFE). In addition to copolymerized units of TFE, this type of fluoroelastomer contains copolymerized units of at least one other monomer such as a PAVE, a FVE, methyl vinyl ether, E, or P.

Fluorinated vinyl ethers (FVE) suitable for use as monomers in the fluoroelastomers employed in this invention include those of the formula
CF₂═CFO—(CF₂)ₘ—(CH₂)ₙ—[O(CF₂)ₓ]_{y}—O-A (I)
where m is an integer between 0 and 4; n is an integer between 0 and 2; x is an integer between 1 and 3; y is an integer between 0 and 6; and A is selected from the group consisting of C₁-C₄ perfluoroalkyl groups, C₁-C₆ perfluoroalkoxy groups, and C₁-C₄ alkyl groups containing between 0 and 8 fluorine atoms.

Perfluoro(alkyl vinyl ethers) (PAVE) suitable for use as monomers include those of the formula
CF₂═CFO(R_{f′}O)ₙ(R_{f″}O)ₘR_{f} (II)
where R_{f′} and R_{f″} are different linear or branched perfluoroalkylene groups of 2-6 carbon atoms, m and n are independently 0-10, and R_{f} is a perfluoroalkyl group of 1-6 carbon atoms.

A preferred class of perfluoro(alkyl vinyl ethers) includes compositions of the formula
CF₂═CFO(CF₂CFXO)ₙR_{f} (III)
where X is F or CF₃, n is 0-5, and R_{f} is a perfluoroalkyl group of 1-6 carbon atoms.

A most preferred class of perfluoro(alkyl vinyl ethers) includes those ethers wherein n is 0 or 1 and R_{f} contains 1-3 carbon atoms. Examples of such perfluorinated ethers include perfluoro(methyl vinyl ether) (PMVE) and perfluoro(propyl vinyl ether) (PPVE). Other useful monomers include compounds of the formula
CF₂═CFO[(CF₂)ₘCF₂CFZO]ₙR_{f} (IV)
where R_{f} is a perfluoroalkyl group having 1-6 carbon atoms, m=0 or 1, n=0-5, and Z=F or CF₃. Preferred members of this class are those in which R_{f} is CF₃, m=1, n=1, and Z=F; and R_{f} is C₃F₇, m=0, and n=1.

Additional perfluoro(alkyl vinyl ether) monomers include compounds of the formula
CF₂═CFO[(CF₂CF{CF₃}O)ₙ(CF₂CF₂CF₂O)ₘ(CF₂)ₚ]CₓF₂ₓ₊₁ (V)
where m and n independently=0-10, p=0-3, and x=1-5.

Preferred members of this class include compounds where n=0-1, m=0-1, and x=1.

Additional examples of useful perfluoro(alkyl vinyl ethers) include
CF₂═CFOCF₂CF(CF₃)O(CF₂O)ₘCₙF₂ₙ₊₁ (VI)
where n=1-5, m=1-3, and where, preferably, n=1.

The fluoroelastomers employed in the compositions of this invention may also contain a cure site for facilitating crosslinking.

Suitable cure sites for crosslinking by organic peroxide/polyfunctional coagent curing systems include, but are not limited to bromine atoms, iodine atoms, or a combination thereof. Such cure sites may be introduced by copolymerization of the fluoroelastomer with cure site monomers that contain a bromine or iodine atom such as fluorinated olefins or fluorinated vinyl ethers. Such cure site monomers are well known in the art (e.g. U.S. Pat. Nos. 4,214,060; 5,214,106; and 5,717,036). Specific examples include, but are not limited to bromotrifluoroethylene (BTFE); 4-bromo-3,3,4,4-tetrafluorobutene-1 (BTFB); and 4-iodo-3,3,4,4-tetrafluorobutene-1 (ITFB). Bis-olefins (U.S. Pat. No. 5,585,449) and fluoroolefins or fluorovinyl ethers that contain a nitrile group (U.S. Pat. No. 4,983,680) may also be employed as cure site monomers in peroxide curable fluoroelastomers.

Instead of copolymerized cure site monomers, or in addition to such units, iodine-containing endgroups, bromine-containing endgroups or mixtures thereof may be present at one or both of the fluoroelastomer polymer chain ends as a result of the use of chain transfer or molecular weight regulating agents during preparation of the fluoroelastomers. The amount of chain transfer agent, when employed, is calculated to result in an iodine or bromine level in the fluoroelastomer in the range of 0.005-5 wt. %, preferably 0.05-3 wt. %.

Examples of chain transfer agents include iodine-containing compounds that result in incorporation of bound iodine at one or both ends of the polymer molecules. Methylene iodide; 1,4-diiodoperfluoro-n-butane; and 1,6-diiodo-3,3,4,4,tetrafluorohexane are representative of such agents. Other iodinated chain transfer agents include 1,3-diiodoperfluoropropane; 1,6-diiodoperfluorohexane; 1,3-diiodo-2-chloroperfluoropropane; 1,2-di(iododifluoromethyl)-perfluorocyclobutane; monoiodoperfluoroethane; monoiodoperfluorobutane; 2-iodo-1-hydroperfluoroethane, etc. Also included are the cyano-iodine chain transfer agents disclosed European Patent 0868447A1. Particularly preferred are diiodinated chain transfer agents.

Examples of brominated chain transfer agents include 1-bromo-2-iodoperfluoroethane; 1-bromo-3-iodoperfluoropropane; 1-iodo-2-bromo-1,1-difluoroethane and others such as disclosed in U.S. Pat. No. 5,151,492.

Suitable cure sites for crosslinking by polyhydroxy curing systems include, but are not limited to trifluoroethylene; 3,3,3-trifluoropropene-1; 1,2,3,3,3-pentafluoropropylene; 1,1,3,3,3-pentafluoropropylene; 2,3,3,3-tetrafluoropropene.

Suitable cure sites for crosslinking by organotin, diaminobisphenol AF, 3,3′-diamonobenzidinene, or ammonia generating curatives include, but are not limited to comonomers such as fluorovinyl ethers or fluoroolefins containing pendent nitrile groups. Examples include perfluoro(8-cyano-5-methyl-3,6-dioxa-1-octene) (8-CNVE) and the nitrile-containing cure site monomers disclosed in U.S. Pat. No. 6,211,319 B1.

Specific examples of fluoroelastomers suitable for use in the compositions of this invention include, but are not limited to elastomers comprising copolymerized units selected from the group consisting of a) VF₂/HFP, b) VF₂/HFP/TFE, c) VF₂/PMVE, d) VF₂/PMVE/TFE, e) VF₂/TFE/P; f) TFE/P; g) E/TFE/PMVE and h) TFE/PMVE. Preferably, these elastomers further comprise at least one type of cure site described above. Most preferably, the fluoroelastomers employed in the compositions of this invention further comprise copolymerized units of either a bromine-, iodine-, or nitrile group-containing cure site monomer.

A preferred fluoroelastomer that may be employed in this invention comprises copolymerized units of i) 38.5 to 74.7 (most preferably 44 to 69.5) mole percent tetrafluoroethylene (TFE), ii) 25 to 60 (most preferably 30 to 55) mole percent perfluoro(methyl vinyl ether) and iii) 0.3 to 1.5 (most preferably 0.5 to 1.0) mole percent of a nitrile group—containing cure monomer.

Fluoroelastomers employed in this invention may be manufactured by such well-known processes as those described in Apotheker et al. (U.S. Pat. No. 4,214,060), Breazeale (U.S. Pat. No. 4,281,092) or Coughlin et. al. (U.S. Pat. No. 5,789,489).

A preferred cure system, useful for fluoroelastomers containing nitrile-containing cure sites, utilizes bis(aminophenols) or bis(aminothiophenols) of the formulas 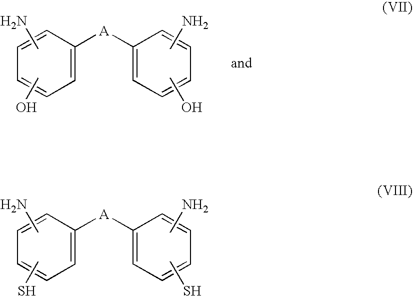
and tetraamines of the formula 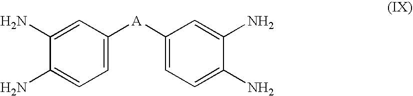
where A is SO₂, O, CO, alkyl of 1-6 carbon atoms, perfluoroalkyl of 1-10 carbon atoms, or a carbon-carbon bond linking the two aromatic rings. The amino and hydroxyl groups in formulas VII and VIII above are interchangeably in the meta and para positions with respect to the group A. Preferably, the curing agent is a compound selected from the group consisting of 4,4′-[2,2,2-trifluoro-1-(trifluoromethyl)ethylidene]bis(2-aminophenol); 4,4′-sulfonylbis(2-aminophenol); 3,3′-diaminobenzidine; and 3,3′,4,4′-tetraminobenzophenone. The first of these is the most preferred and will be referred to as diaminobisphenol AF. The curing agents can be prepared as disclosed in U.S. Pat. No. 3,332,907 to Angelo. Bis(aminophenol) AF can be prepared by nitration of 4,4′-[2,2,2-trifluoro-1-(trifluoromethyl)ethylidene]-bisphenol (i.e. bisphenol AF), preferably with potassium nitrate and trifluoroacetic acid, followed by catalytic hydrogenation, preferably with ethanol as a solvent and a catalytic amount of palladium on carbon as catalyst. The level of curing agent should be chosen to optimize the desired properties of the vulcanizate. In general, a slight excess of curing agent over the amount required to react with all the cure sites present in the polymer is used. Typically, 0.5-5.0 parts by weight of the curative per 100 parts of fluoroelastomer is required. The preferred range is 1.0-2.0 parts.

Peroxides may also be utilized as curing agents. Useful peroxides are those which generate free radicals at curing temperatures. A dialkyl peroxide or a bis(dialkyl peroxide) which decomposes at a temperature above 50° C. is especially preferred. In many cases it is preferred to use a ditertiarybutyl peroxide having a tertiary carbon atom attached to peroxy oxygen. Among the most useful peroxides of this type are 2,5-dimethyl-2,5-di(tertiarybutylperoxy)hexyne-3 and 2,5-dimethyl-2,5-di(tertiarybutylperoxy)-hexane. Other peroxides can be selected from such compounds as dicumyl peroxide, dibenzoyl peroxide, tertiarybutyl perbenzoate, and di[1,3-dimethyl-3-(t-butylperoxy)butyl]carbonate. Generally, about 1-3 parts by weight by weight of peroxide per 100 parts of fluoroelastomer (i.e. 1-3 phr) is used. Another material which is usually blended with the composition as a part of the peroxide curative system is a coagent composed of a polyunsaturated compound which is capable of cooperating with the peroxide to provide a useful cure. These coagents can be added in an amount equal to 0.1 and 10 parts per hundred parts fluoroelastomer, preferably between 2-5 parts per hundred parts fluoroelastomer. The coagent may be one or more of the following compounds: triallyl cyanurate; triallyl isocyanurate; tri(methylallyl)isocyanurate; tris(diallylamine)-s-triazine; triallyl phosphite; N,N-diallyl acrylamide; hexaallyl phosphoramide; N,N,N′,N′-tetraalkyl tetraphthalamide; N,N,N′,N′-tetraallyl malonamide; trivinyl isocyanurate; 2,4,6-trivinyl methyltrisiloxane; and tri(5-norbornene-2-methylene)cyanurate. Particularly useful is triallyl isocyanurate.

Ammonia-generating compounds that may be employed as curing agents in the compositions of this invention are those that are capable of generating ammonia at temperatures of 40° C.-330° C., preferably between 90° C.-220° C. Illustrative examples of these compounds include aldehyde ammonia condensation products, including acetaldehyde ammonia; and other compounds, such as hexamethylenetetramine; carbamates, for example t-butyl carbamate, benzyl carbamate, and HCF₂CF₂CH(CH₃)OCONH₂; urea; urea hydrochloride; thiourea; amides, such as phthalamide; metal ammine complexes, such as tetraamine copper (II)sulfate hydrate; ammonia-Lewis acid adducts; carboxamides, such as oxamic acid; biuret; unsubstituted amidines, such as formamidine, formamidine hydrochloride, and formamidine acetate; and unsubstituted or substituted triazine derivatives such as those disclosed in WO 01/27194. When present in the compositions of this invention, the level of ammonia generating compound is generally from 0.05 to 5 phr, preferably 0.1-1 phr.

The compositions of the present invention also contain barium sulfate filler, said barium sulfate having an average primary particle size less than 200 nm, preferably 100 nm or less. Commercially available nanoparticle barium sulfates include Sachtoperse HP, HP—N and HP-D from Sachtleben Chemie GMBH (Germany). The level of such barium sulfate in the compositions of this invention is between 0.1 and 50 phr, preferably between 5 and 30 phr.

Optionally, the compositions of the invention may further comprise at least one other nanoparticle filler, i.e. a filler having an average primary particle size less than 200 nm, preferably 100 nm or less, such as titanium dioxide, alumina, silica or polytetrafluoroethylene (PTFE). When present, the level of each of such nanoparticle fillers in the composition of this invention is between 0.1 and 50 phr, preferably between 5 and 30 phr.

Conventional additives typically employed in the elastomers industry including stabilizers, plasticizers, lubricants, other fillers such as PTFE micropowders etc., and processing aids can be incorporated into the compositions of the present invention, provided they have adequate stability for the intended service conditions. In particular, low temperature performance can be enhanced by incorporation of perfluoropolyethers.

The curable compositions of the present invention are useful in production of gaskets, tubing, and seals. Such articles are generally produced by compression molding a formulation of the curable composition of the invention compounded with various additives, curing the part, and then subjecting it to a post cure cycle. The cured compositions have excellent physical properties, including compression set. They are particularly useful in applications wherein they will be exposed to reactive plasmas such as in equipment for the manufacture of semiconductor chips.

The invention is now illustrated by certain embodiments wherein all parts are by weight unless otherwise specified.

### EXAMPLES

### Test Methods

Cure Characteristics

Cure characteristics were measured using a Monsanto Moving Die Rheometer (MDR 2000) instrument under the following conditions:
Moving die frequency: 1.66 Hz
Oscillation amplitude: 0.5
Temperature: 199° C.
Duration of test: 30 minutes

The following cure parameters were recorded:
M_{H}: maximum torque level, in units of dN·m
M_{L}: minimum torque level, in units of dN·m
tₛ2: minutes to 2 units rise above M_{L}
t_{c}90: minutes to 90% of maximum torque

Test specimens were prepared from elastomer compounded with appropriate additives, as described in the formulations listed in the Examples below. Compounding was carried out on a rubber mill. The milled composition was formed into a sheet and a sample was died out into a disk to form the test specimen.

Tensile Properties

Unless otherwise noted, stress/strain properties were measured on K214 o-rings. Physical property measurements were obtained according to methods described in ASTM D1414. The following parameters were recorded:
M₁₀₀, modulus at 100% elongation in units of MPa
T_{B}, tensile strength at break in units of MPa.
E_{B}, elongation at break in units of %

Compression set of O-ring samples was determined in accordance with ASTM D1414.

Plasma Resistance Testing

Sections of o-rings being tested were placed on a 6-inch wafer located at the center of a parallel plate (RIE) etching chamber. Plasma resistance was measured under three different conditions:

| | Gas | | |
|---|---|---|---|
| | NF₃/Ar | O₂ | CF₄/O₂ |
| Flow Rate (sccm¹) | 13/37 | 50 | 45.5/4.5 |
| Power (W) | 900 | 900 | 900 |
| Pressure (Pa) | 31 | 13 | 13 |
| Time (hour) | 1 | 1 | 1 |

¹sccm is standard cubic centimeters per minute

Percent Weight Loss was determined by measuring the weight of the o-ring section being tested before and after exposure to plasma.

Particle Generation (particles per mm² surface area of o-ring) was measured using o-rings that were exposed to NF₃/Ar plasma under the above conditions. Particles were shaken free from the o-ring surface by ultrasonication and collected. The collected particles were measured by an APSS/Liquilaz (Particle Measuring Systems) and are reported as number per mm² surface area.

The following fluoroelastomer polymers were used in the Examples:

Fluoroelastomer 1—A terpolymer containing 68.2 mole percent units of TFE, 31.0 mole percent units of PMVE and 0.80 mole percent units of 8-CNVE was prepared according to the general process described in U.S. Pat. No. 5,789,489.

Fluoroelastomer 2—A copolymer containing 34 weight percent units of vinylidene fluoride, 38 weight percent units of perfluoro(methyl vinyl ether), 26 weight percent units of tetrafluoroethylene and 2 weight percent units of 4-bromo-3,3,4,4-tetrafluorobutene-1 (BTFB) was prepared according to the general process described in U.S. Pat. No. 4,214,060.

### Example 1

Samples of the invention (1 to 5), containing barium sulfate having an average particle size of 100 nm, and Comparative Samples (A & B), containing barium sulfate having an average particle size of 1 micron were made on a 2-roll rubber mill. The formulations are shown in Table I. Curing characteristics are also shown in Table I. For Sample 5, the MDR was run at 177° C. for 20 minutes.

O-rings were molded under the following conditions: Samples 1 and 2: 210° C. for 30 minutes, Sample 3: 200° C. for 6 minutes, Sample 4: 200° C. for 8 minutes, Sample 5: 177° C. for 10 minutes, Comparative Sample A: 200° C. for 17 minutes and Comparative Sample B: 200° C. for 10 minutes. The resulting o-rings, except for Sample 5, were post cured under nitrogen for 26 hours at 305° C. after a slow ramp from room temperature to 305° C. Sample 5 o-rings were post cured in an air oven at 232° C. for 24 hours. Physical properties of the post cured o-rings are shown in Table I.

TABLE I

| | | | | | | Comparative | Comparative |
|---|---|---|---|---|---|---|---|
| | Sample 1 | Sample 2 | Sample 3 | Sample 4 | Sample 5 | Example A | Example B |
| Formulation (phr) | | | | | | | |
| Fluoroelastomer 1 | 100 | 100 | 100 | 100 | 100 | 100 | 100 |
| Sachtoperse HU-N¹ | 10 | 0 | 10 | 18 | 20 | 0 | 0 |
| Sachtoperse HU-D² | 0 | 10 | 0 | 0 | 0 | 0 | 0 |
| Blanc Fixe F³ | 0 | 0 | 0 | 0 | 0 | 10 | 10 |
| DABPAF⁴ | 1.75 | 1.75 | 0 | 1.75 | 0 | 1.75 | 0 |
| Urea | 0 | 0 | 0.3 | 0.1 | 0 | 0 | 0.3 |
| Diak 8⁵ | 0 | 0 | 0 | 0 | 2 | 0 | 0 |
| PLC(DBPH)-68⁶ | 0 | 0 | 0 | 0 | 3 | 0 | 0 |
| Tensile Properties | | | | | | | |
| M₁₀₀ (MPa) | 1.6 | 1.8 | 1.8 | 2.9 | 3.4 | 1.4 | 1.4 |
| T_{B} (MPa) | 10.1 | 9.1 | 6.2 | 6.4 | 9.6 | 6.3 | 5.2 |
| E_{B} (%) | 161 | 195 | 214 | 185 | 195 | 161 | 199 |
| Hardness, Shore A | 66 | 66 | 65 | 70 | 74 | 63 | 64 |
| Compression Set @ | 18 | 21 | 33 | 18 | 33 | 13 | 21 |
| 204° C., 70 hours | | | | | | | |
| Cure Characteristics | | | | | | | |
| ML (dN · m) | 2.77 | 3.14 | 4.1 | 3.6 | 4.3 | 2.3 | 2.63 |
| MH (dN · m) | 6.50 | 7.19 | 11.51 | 13.2 | 16.8 | 11.97 | 10.55 |
| Ts2 (minutes) | 1 | 1 | 2.2 | 0.03 | 1.17 | 4.5 | 1.6 |
| Tc90 (minutes) | 28 | 29 | 5.3 | 2.28 | 4.75 | 11.8 | 4.5 |

¹100 nm average particle size barium sulfate (available from Sachtleben Chemie GMBH)
²organic surface treated 100 nm average particle size barium sulfate (available from Sachtleben Chemie GMBH)
³1 micron average particle size barium sulfate (available from Sachtleben Chemie GMBH)
⁴diaminobisphenol AF
⁵trimethallylisocyanurate (available from DuPont Dow Elastomers L.L.C.)
⁶2,5-dimethyl-2,5-di(t-butylperoxy)hexane organic peroxide (available from Elastochem, Inc.)

### Example 2

Fresh o-ring Samples of the invention and Comparative Samples were prepared according to the process disclosed in Example 1. Percent weight loss after plasma exposure was measured according to the above Test Method. Results are shown in Table II.

TABLE II

| Percent | | | |
|---|---|---|---|
| Weight Loss | CF₄/O₂ Plasma | O₂ Plasma | NF₃/Ar Plasma |
| Sample 1 | 1.04% | 1.69% | 1.39% |
| Sample 2 | 1.06 | 1.98 | 1.47 |
| Sample 3 | 1.06 | 1.77 | 1.36 |
| Sample 4 | 0.61 | 1.08 | 0.94 |
| Sample 5 | 0.56 | 1.08 | 0.66 |
| Comparative | 1.59 | 3.25 | 2.08 |
| Sample A | | | |
| Comparative | 1.53 | 3.26 | 2.19 |
| Sample B | | | |

Particle generation due to exposure to NF₃/Ar plasma was measured according to the Test Method. Results are shown in Table III.

TABLE III

| Particle | | | | | | | | | | | | | | | | |
|---|---|---|---|---|---|---|---|---|---|---|---|---|---|---|---|---|
| Distribution | | | | | | | | | | | | | | | | |
| (per mm²) | | | | | | | | | | | | | | | | |
| Size range, | | | | | | | | | | | | | 10- | 15- | 20- | |
| um | 0.5-0.6 | 0.6-0.7 | 0.7-0.8 | 0.8-0.9 | 0.9-1 | 1-1.5 | 1.5-2 | 2-3 | 3-4 | 4-5 | 5-7.5 | 7.5-10 | 15 | 20 | 25 | Total |
| Sample 1 | 2323 | 783 | 414 | 243 | 145 | 315 | 108 | 75 | 25 | 10 | 4 | 1 | 1 | 0 | 0 | 4450 |
| Sample 2 | 3259 | 1081 | 591 | 313 | 184 | 296 | 71 | 34 | 11 | 3 | 2 | 0 | 0 | 0 | 0 | 5846 |
| Sample 3 | 3702 | 1062 | 476 | 237 | 124 | 199 | 56 | 37 | 14 | 5 | 3 | 1 | 0 | 0 | 0 | 5916 |
| Sample 4 | 1108 | 343 | 174 | 97 | 51 | 75 | 21 | 13 | 5 | 2 | 1 | 0 | 0 | 0 | 0 | 1890 |
| Sample 5 | 1945 | 955 | 575 | 352 | 223 | 453 | 133 | 88 | 43 | 19 | 17 | 4 | 3 | 0 | 0 | 4810 |
| Comp. | 165412 | 83585 | 56175 | 33532 | 21740 | 43047 | 11216 | 2864 | 231 | 58 | 0 | 29 | 0 | 0 | 10 | 417897 |
| Sample A | | | | | | | | | | | | | | | | |
| Comp. | 144877 | 79481 | 54708 | 34689 | 23165 | 49625 | 14776 | 5563 | 591 | 79 | 8 | 31 | 10 | 0 | 20 | 407623 |
| Sample B | | | | | | | | | | | | | | | | |

### Example 3

Sample 6, a sample of the invention containing barium sulfate having an average particle size of 100 nm, and Comparative Sample C, containing barium sulfate having an average particle size of 1 micron were made on a 2-roll rubber mill. The formulations are shown in Table IV. Curing characteristics are also shown in Table IV.

O-rings were molded at 165° C. for 20 minutes and post cured in an air oven at 180° C. for 20 hours. Physical properties of the post cured o-rings are shown in Table IV.

TABLE IV

| | | Comparative |
|---|---|---|
| | Sample 6 | Example C |
| Formulation, phr | | |
| Fluoroelastomer 2 | 100 | 100 |
| Sachtoperse HU-N¹ | 20 | 0 |
| Blanc Fixe F² | 0 | 20 |
| PLC(DBPH)-68³ | 2 | 2 |
| TAIC DLC-A 72%⁴ | 4.2 | 4.2 |
| Tensile Properties | | |
| M₁₀₀ (MPa) | 1.7 | 1.6 |
| T_{B} (MPa) | 6.7 | 5.2 |
| E_{B} (%) | 232 | 242 |
| Hardness, Shore A | 66 | 66 |
| Compression Set @ | 28 | 32 |
| 204° C., 70 hours | | |
| Cure | | |
| Characteristics | | |
| ML (dN · m) | 1.77 | 1.40 |
| MH (dN · m) | 24.03 | 23.07 |
| Ts2 (minutes) | 0.57 | 0.57 |
| Tc90 (minutes) | 1.47 | 1.53 |

¹100 nm average particle size barium sulfate (available from Sachtleben Chemie GMBH)
²1 micron average particle size barium sulfate (available from Sachtleben Chemie GMBH)
³2,5-dimethyl-2,5-di(t-butylperoxy)hexane organic peroxide (available from Elastochem, Inc.)
⁴triallylisocyanurate on silicon dioxide (available from Natrochem, Inc.)

### Example 4

Fresh o-ring Samples of the invention and Comparative Samples were prepared according to the process disclosed in Example 3. Percent weight loss after exposure to NF₃/Ar plasma was measured according to the above Test Method. Results are shown in Table V.

TABLE V

| | Percent Weight |
|---|---|
| | Loss |
| Sample 6 | 1.06 |
| Comparative | 1.38 |
| Sample C | |

Particle generation due to exposure to NF₃/Ar plasma was measured according to the Test Method. Results are shown in Table VI.

TABLE VI

| Particle | | | | | | | | | | | | | | | | |
|---|---|---|---|---|---|---|---|---|---|---|---|---|---|---|---|---|
| Distribution | | | | | | | | | | | | | | | | |
| (per mm²) | | | | | | | | | | | | | | | | |
| Size range, | | | | | | | | | | | | | | 15- | 20- | |
| um | 0.5-0.6 | 0.6-0.7 | 0.7-0.8 | 0.8-0.9 | 0.9-1 | 1-1.5 | 1.5-2 | 2-3 | 3-4 | 4-5 | 5-7.5 | 7.5-10 | 10-15 | 20 | 25 | Total |
| Sample 6 | 3213 | 1289 | 648 | 343 | 173 | 249 | 42 | 17 | 4 | 2 | 1 | 2 | 2 | 0 | 0 | 5986 |
| Comp. | 385610 | 179056 | 87438 | 46200 | 24572 | 26408 | 1508 | 0 | 0 | 0 | 0 | 36 | 0 | 0 | 0 | 750829 |
| Sample C | | | | | | | | | | | | | | | | |

1. A curable composition comprising:
A. a fluoroelastomer;
B. a curative; and
C. 0.1 to 50 parts by weight barium sulfate per hundred parts by weight fluoroelastomer, said barium sulfate having an average particle size of less than 200 nm.

2. A curable composition of claim 1 wherein said barium sulfate is present in said composition at a level of 5 to 30 parts by weight per hundred parts by weight fluoroelastomer.

3. A curable composition of claim 2 wherein said barium sulfate has an average particle size of 100 nm or less.

4. A curable composition of claim 1 wherein said fluoroelastomer comprises copolymerized units selected from the group consisting of a) vinylidene fluoride and hexafluoropropylene; b) vinylidene fluoride, hexafluoropropylene and tetrafluoroethylene; c) vinylidene fluoride and perfluoro(methyl vinyl ether); d) vinylidene fluoride, perfluoro(methyl vinyl ether) and tetrafluoroethylene; e) tetrafluoroethylene and propylene; f) tetrafluoroethylene, propylene and vinylidene fluoride; g) ethylene, tetrafluoroethylene and perfluoro(methyl vinyl ether); and h) tetrafluoroethylene and perfluoro(methyl vinyl ether).

5. A curable composition of claim 1 wherein said curative is selected from the group consisting of i) an organic peroxide, ii) a bis(aminophenol), iii) a bis(aminothiophenol), and iv) a compound that decomposes at a temperature between 40° C. and 330° C. to generate ammonia.
